(19) United States
(12) Patent Application Publication
(10) Pub. No.: US 2005/0055675 A1
(43) Pub. Date: Mar. 10, 2005

(54) Generation of software objects from a hardware description

(76) Inventors: William Neifert, Arlington, MA (US); Joshua Marantz, Brookline, MA (US); Richard Sayde, Carlisle, MA (US); Joseph Tatham, Arlington, MA (US); Alan Lehotsky, Carlisle, MA (US); Andrew Ladd, Maynard, MA (US); Mark Seneski, Roslindale, MA (US); Aron Atkins, Arlington, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/703,406

(22) Filed: Nov. 7, 2003

Related U.S. Application Data
(60) Provisional application No. 60/424,930, filed on Nov. 8, 2002.

(51) Int. Cl. G06F 9/44; G06F 9/45

(52) U.S. Cl. 717/135; 717/138; 717/141; 717/154; 703/22

(57) ABSTRACT

System and methods for generating a software object that simulates the operation of a hardware device from a register transfer level description of the device written in a hardware description language, such as Verilog. The invention uses global analysis techniques (i.e., analysis of the design of the electronic device as a whole) to produce cycle accurate simulations of hardware devices. These global analysis techniques include generation of a static schedule for the simulation, based on clock edges and other selected signals present in the design. In some embodiments, reusing results from a previous simulation optimizes the simulation. In some embodiments, the software object that is generated may be linked with software that is being developed or tested for use with the hardware that is simulated by the software object. The software that is being developed or tested may interact with the simulation using a high-throughput application program interface (API).

### CROSS-REFERENCE TO RELATED APPLICATION

This application claims priority to and the benefit of, and incorporates herein by reference, in its entirety, provisional U.S. patent application Ser. No. 60/424,930, filed Nov. 8, 2002.

### FIELD OF THE INVENTION

The invention relates to the field of simulation of electronic hardware devices. In particular, the invention relates to compilation of a description of an electronic device, such as a Verilog RTL description into a software object that simulates the behavior of the device.

### BACKGROUND OF THE INVENTION

Electronic hardware design is typically performed using register transfer level (RTL) descriptions of the device being designed. Hardware description languages, such as Verilog provide hardware designers with an ability to describe the electronic devices that they are designing, and to have those descriptions synthesized into a form that can be fabricated.

The process of producing electronic devices is time consuming and expensive. As a result various simulation systems have been developed to permit hardware designs to be verified prior to actually producing an electronic device. Typically, a description of an electronic device is exercised using a simulator. The simulator generally includes a simulation kernel that runs the simulation either in software, or using simulation hardware, which typically consists of a collection of programmable logic devices or specially designed processing units. Use of simulation for the purpose of verifying hardware designs is a regular part of the hardware design cycle.

Simulation for verification purposes often needs to be as accurate as possible, including being accurate with respect to timing. This degree of accuracy can cause such simulations to run slowly. Even when using simulation hardware, it is not uncommon to encounter differences in speed between the actual electronic device and the simulation by factors on the order of tens of thousands to millions. For large simulations, many software simulators can execute a simulation at a rate between 1 Hz and 100 Hz, depending on the simulator and the electronic device being simulated, whereas it is not uncommon for an actual electronic device to run at clock speeds of 500 MHz or more. This means that it could take weeks or even months to simulate one second of the operation of an electronic device. Even using a hardware-based simulator, which may execute a simulation at a rate of 1000 Hz to 1 MHz, the simulator may still be hundreds or thousands of times slower than the actual device.

While much of this accuracy and detail may be warranted for some verification tasks, the slow speed of most simulators makes their use impractical for many purposes, e.g. developing and testing software that uses the hardware being simulated.

Many current hardware designs are intended to be used extensively in conjunction with software, such as software drivers or applications. Due to the slow speed of current simulators, it may be necessary to delay much of the design and testing of such software until after early versions of the actual hardware become available. As a result, software development may not be possible until relatively late in the design cycle, potentially causing significant delays in bringing some electronic devices to market.

In view of the above, it would be desirable to provide a high-performance simulation system, capable of simulating an electronic device based on a description of the device written in a hardware description language.

### SUMMARY OF THE INVENTION

The present invention provides a system and methods that transform a coded description of an electronic device written in a hardware description language, such as Verilog RTL, into a simulation of the device. The invention uses global analysis techniques (i.e., analysis of the design of the electronic device as a whole) to produce cycle-accurate simulations of hardware devices. These global analysis techniques may include generation of a static schedule for the simulation, based on clock edges and other selected signals present in the design. In some embodiments, the resulting simulation takes the form of a software object that can be linked with software that is being designed and tested to use the device being simulated.

The global analysis techniques may be used to optimize the performance of the resulting simulation. For example, the generation of a static schedule may be used to provide a simulation in which the execution time of the simulation maintains a near-linear relationship with the size of the design of the electronic device.

Additionally, in some embodiments, the simulation is only cycle-accurate, rather than completely timing-accurate. This permits further speed gains in the simulators produced using the system and methods of the invention. Such cycle accuracy is sufficient for many tasks, including the development and testing of software designed to interact with the hardware that is being simulated.

In addition to other speed gains, the simulations produced by the system and methods of the invention may use a high-speed API (Application Program Interface) for interactions between the simulation and software that is being designed and tested in conjunction with the simulated hardware. Because the simulation may be linked with the software being tested to form a single executable simulation system, the throughput of the API is not restricted by the speed of communication between the software and an external simulation device or simulation kernel.

In one aspect, the invention provides a method of developing and testing a software program for use with a hardware device, e.g., before development of the hardware device is complete. The method involves transforming a coded description of the hardware device into a software system that simulates the hardware device. The process of transforming the coded description into a software system that simulates the hardware device includes performing a global analysis to determine a schedule for the software system.

In another aspect, the invention provides a method of developing and testing a software program for use with a hardware device by transforming an RTL description of the hardware device into a software object that simulates the hardware device. Global analysis is used on a representation of the RTL description during the transformation process.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 is a block diagram showing the flow of a system for generating simulations according to an embodiment of the invention;

FIG. 2 is a block diagram showing the flow of a simulation generator according to an embodiment of the invention;

FIG. 3 is a block diagram showing a global analysis module of a simulation generator according to an embodiment of the invention;

FIG. 4 is a flowchart showing the operation of a scheduling phase of global analysis according to an embodiment of the invention;

FIG. 5 is a block diagram showing the execution order of the schedules generated by the scheduling phase in an embodiment of the invention;

FIG. 6 shows the structure of a system according to an embodiment of the invention that integrates software that is being designed and tested for use with an electronic device and a simulation of the electronic device, interacting through a high-speed API; and

FIG. 7 is a block diagram of a general purpose computer on which instructions implementing an embodiment of the invention may be executed.

### DETAILED DESCRIPTION

The present invention converts a description of an electronic device, such as a Verilog RTL description, into a software object that simulates the electronic device. The electronic device may be an electronic chip, a small functional block of a chip, numerous chips which make up a complete system, or any other combination of electronic components. A software object generated in accordance with an embodiment of the invention may, for example, be used to simulate an electronic device, in order to facilitate development and testing of software that will be used with the electronic device prior to the device being available. Use of such a simulation can permit software development to proceed in parallel with hardware development, reducing overall time to market.

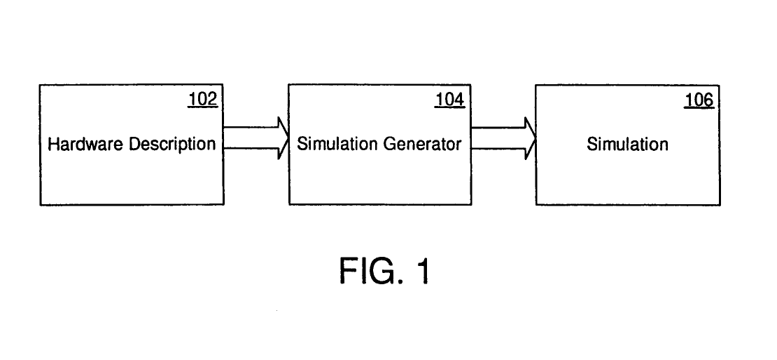

FIG. 1 shows an overview of the flow of the system of the present invention. In typical use, a description 102 of an electronic device is prepared as part of the development effort on the electronic device. In one embodiment, this description is expressed as one or more Verilog RTL files. Other embodiments may permit different types of hardware descriptions or hardware description languages to be used in accordance with the invention.

In general, the description 102 should describe a complete hardware system, such as an electronic device, in sufficient detail to permit a software simulation of the system to be generated. Preferably, the hardware is described at a register transfer level, rather than at a lower level, such as a gate level. Also, interconnections within the hardware may be described as vectors, rather than requiring that each wire of, for example, a wide bus be described separately.

The description 102 is provided to a simulation generator 104, which converts the description 102 into a simulation 106. The simulation generator 104, which will be described in greater detail below, translates the description 102 into an internal format. Preferably, this internal format facilitates global analysis of the hardware design embodied in description 102. The simulation generator 104 performs such global analysis to optimize the simulation that it generates. As will be described in detail below, global analysis refers to analysis that is performed on the entire hardware design, crossing module boundaries, rather than on a module-by-module or smaller scale basis. As part of this global analysis, the simulation generator 104 schedules the elements of the hardware design with regard to relevant clock edges and other events.

The output of simulation generator 104 is a simulation 106, which is preferably in the form of a software object that may be used to simulate the hardware design embodied in the description 102. In some embodiments, the simulation is a software object with a defined interface, permitting software systems designed to work with the hardware design to be linked to the simulation 106 for development and testing. In some embodiments, the simulation 106 need only be cycle-accurate, rather than timing-accurate, since the simulation is used primarily to permit early design and testing of software for use with a hardware design.

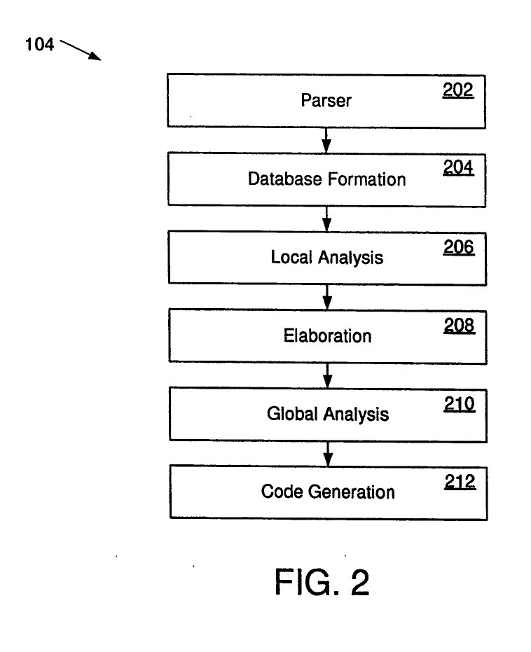

FIG. 2 illustrates the components of a simulation generator 104 and their operation. The simulation generator 104 includes a parser 202, a database formation module 204, a local analysis module 206, an elaboration module 208, a global analysis module 210, and a code generation module 212.

The parser 202 parses the description 102. The output of the parser 202 is a parsed version of the description 102, which can be converted into an intermediate format for use by later stages of the simulation generation process by database formation module 204. Specifically, the parser takes as input the description 102, and uses known parsing techniques to produce a data structure that represents the description 102, and that can be examined and manipulated by later stages more readily than the original textual form of the description 102. The parser 202 also typically provides a set of application program interfaces (APIs) for examining and manipulating the data structure that has been created to represent the description 102. Generally, the parser 202 also performs a syntax check on its input. In some embodiments, a synthesizable subset of Verilog RTL is parsed in this stage.

The parser 202 may be a commercially available parser, or a custom parser, built using known parsing techniques. For example, for parsing Verilog RTL, the Cheetah Verilog Analyzer by Interra Technologies, Inc., of Santa Clara, Calif., may be used.

The database formation module 204 decomposes the output of the parser 202 into a database for use by later stages of the simulation generation process. The database produced at this stage preferably decomposes the design in a manner that preserves all of the information that will be needed at later stages, and provides the information in a queryable form that is readily accessible. Specifically, the database formation module 204 takes as input the data structure produced by the parser 202, and transfers the information in that data structure into a database. The database produced by the database formation module 204 provides a representation of parsed form of the description 102 that is independent of the hardware description language that was used to write the description 102.

The database generated by the database formation module 204 breaks the design (i.e. the hardware design embodied in the description 102 and represented by the database created by the database formation module 204) into “flow nodes” that represent the design. These flow nodes are interconnected to form a directed graph that represents the signal or data flow of the hardware design, embodied in the description 102, at a module level (i.e., the flow nodes represent modules in the design). A module is a block of code in the description 102 that provides a particular function, and that typically may be replicated in the design. For example, a module might represent an adder, or a memory.

Use of the database formation module 204 permits multiple front-ends (i.e. parsers), each of which may read and parse different hardware description formats to share a common simulation database format. Use of a common database format in later stages of the simulation generation process permits design rule checks and other analysis to be built in a consistent manner.

In some embodiments, certain information that was present in the description 102 may be discarded by the database formation module 204. For example, if the simulation is only cycle accurate, some information on timing may be discarded. Information on signal strength that may be present in some Verilog modules may also be discarded at this stage in some embodiments. Generally, the database formation module 204 may omit from the database any information in the description 102 that will not contribute to the hardware being designed (i.e., non-synthesizable portions of the description 102).

The local analysis module 206 performs local flow analysis to create a signal flow graph (also referred to as a data flow, or design flow) for the design. The signal flow graph is a directed graph that represents signal flow through each module in the design. In some embodiments, the signal flow graph is constructed so that signals can be traced backwards to their sources by traversing the graph.

The elaboration module 208 fills in the logic for any module that is used in more than one unique form in the design. For example, if a module is parameterized, there may be multiple different “versions” of the same module present in the design, each of which must be fully expanded within the design (i.e., by being added to the database). Examples of parameterized modules include a memory with configurable data width and data depth, or a multiplier with multiple clock stages. If one instance of a configurable memory module used in a design is four bits wide, and another is eight bits wide, then the elaboration module 208 will a copy of the module for the four-bit wide version, and a copy of the module (altered according to the parameters) for the eight-bit wide version. The instances of modules and parameterized structures created by elaboration module 208 will typically be added into the database and the signal flow graph. Thus, “elaborated” modules are modules that have been instantiated and fully expanded within the design, whereas “unelaborated” modules have not.

Next, global analysis module 210 analyzes the design as a whole. This may involve determining schedules for the blocks that make up the design, and partitioning the blocks into the schedules. Global analysis and scheduling techniques in accordance with some embodiments of the invention will be described in detail below. Advantageously, by analyzing the design as a whole, and determining how to schedule the various blocks of the design using global analysis module 210, substantial performance gains may be achieved in the resulting simulation.

After global analysis and scheduling is complete, the code generation module 212 generates program code for the simulation, based on the information in the database, the signal flow, and the schedules. In one embodiment, code for the simulation is generated as a set of C++ classes with one such C++ class representing each module in the design. Schedule dependency information that was determined in the global analysis module 210 is used to generate calls to the various methods in these classes in the correct order. The schedule information is also used to generate a cycle-simulation driver function that analyzes the input signals and calls the specific clock-edge or signal change-sensitive schedules to simulate the operation of the circuit.

The code generation module 212 may also provide a variety of information that may be used for debugging purposes, such as information that may be used to access internal memory associated with specific signals in the design via known PLI (Programming Language Interface) or VCD (Value Change Dump) generation interfaces.

In some embodiments, in which the code generated by the code generation module 212 includes code expressed in a high-level programming language, such as C, C++, Java, or any other suitable programming language, the code generation module 212 may invoke an appropriate compiler to compile the code into object code for the simulator. This object code provides a linkable simulation of the electronic device that may be used to develop and test software that is being designed to use the electronic device defined by the description.

It will be understood that various embodiments of the code generation module 212 may generate code in most any programming language that may be compiled into an appropriate set of object files, executables, or any other format that may provide a simulation of an electronic device that may be used with other software. In some embodiments, machine code, object files, or other usable formats may be directly generated by the code generation module 212, without use of a compiler.

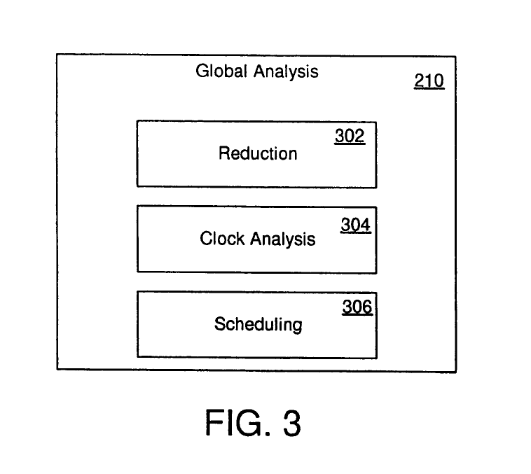

Referring now to FIG. 3, an overview of the global analysis module 210 is described. The global analysis module 210 includes a reduction module 302, a clock analysis module 304, and a scheduling module 306, all of which perform global operations on the design using the signal flow graph and database generated by other modules of the system.

The reduction module 302 transforms and simplifies the design through techniques such as alias creation, constant propagation, removal of redundant logic, and generation of resolution functions. Alias creation, which may be used in some embodiments of the invention, is the process of determining that two or more nets (i.e., connections, such as wires, between structural entities (such as gates or registers) in the design), though named differently, actually refer to the same net. The numerous nets that all refer to the same physical net may be collapsed into a single net in the design, reducing memory requirements for the design, and simplifying the design. Since nets represent connections through which signals flow, the signal flow graph will be affected by these simplifications to the design.

To perform alias creation, the design is traversed, searching for specific constructs in the design that trigger alias creation. Any nets that are to be aliased are added to a ring of equivalent nets, one of which is selected as the “master” net for the ring of equivalents. The master net is the only one of the nets that will be represented in the signal flow graph. The signal flow graph is transformed so that all flow nodes in the graph that define any member of the alias ring instead define the master net.

In some cases, when this is done, one or more modules may become unique in the design. When this occurs, the system may replicate the corresponding unelaborated design and flow elements, modify the design and flow to point to the newly-unique modules, remove the old elaboration of those modules, and re-elaborate the modules and flow, as described above.

Constant propagation refers to the removal of logic that is made redundant due to the application of constant inputs. For example, an AND gate that has a constant zero as one of its inputs will always produce a zero, and can be removed. Similarly, other redundant logic, such as back-to-back inverters, or back-to-back buffers may be removed by the reduction module 302. Constant propagation and removal of redundant logic can be achieved through use of known binary decision diagram packages, such as, such as BuDDy, by Jørn Lind-Nielsen, or the CU Decision Diagram Package, available through the Department of Electrical and Computer Engineering at the University of Colorado at Boulder.

Both constant propagation and removal of redundant logic may cause a module in the design to become unique in the design (e.g., when one instance of the module can be reduced, and others cannot). When this occurs, the modules and flow may be re-elaborated, as described above with reference to the elaboration module 208.

In addition, the reduction module 302 may also generate resolution functions. Where there are multiple drivers of a net, a resolution function may be generated to determine how to resolve the value of the net. The reduction module 302 modifies the elaborated and unelaborated signal flow graphs, inserting resolution functions when multiply-driven nets are found.

The clock analysis module 304 finds clocks in the system, and attempts to determine which clocks are equivalent to each other. This permits the clock analysis module 304 to determine which portions of a design are synchronous with each other.

In many designs, due to the high fanout of clock lines, clocks are buffered using groups of logic gates to drive the clock fanout. Advantageously, by analyzing the clocks that are found in the design to determine which are equivalent to each other, the design may be simplified, and the number of unique clocks that are handled during scheduling (i.e. the determination of which blocks within the design will be executed at particular clock edges, as described below) may be decreased.

Generally, known techniques may be used to determine the equivalence of clocks in a design. Known binary decision diagram packages, such as BuDDy, or the CU Decision Diagram Package, as described above, are able to perform this type of analysis. Alternatively, known logic reduction and minimization techniques may be used to determine which clocks are equivalent to each other.

Once the clock analysis module 304 has found all of the relevant clocks in the system, the scheduler 306 determines under what conditions and in which order the various components of the design will execute. As will be described in detail hereinbelow, the execution conditions are generally based on clocks in the design, and the execution order is typically determined from component dependencies in the design. Other considerations, such as cache locality, may also be taken into consideration by the scheduler 306.

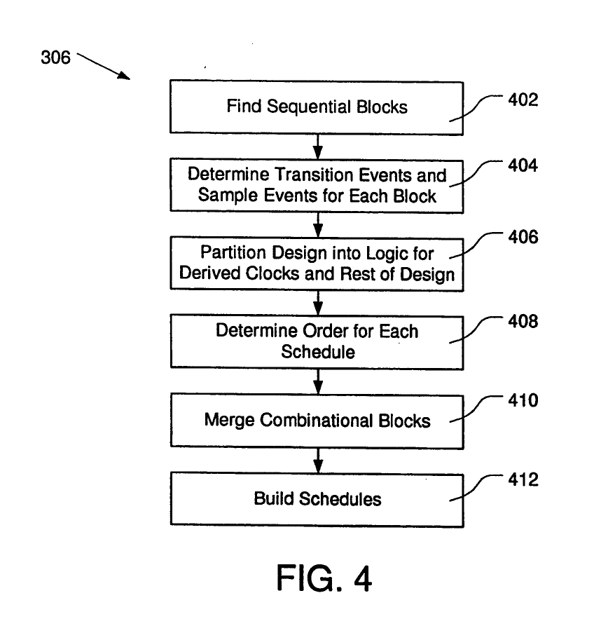

Referring now to FIG. 4, a high-level flow of the scheduler 306 is shown. For the purpose of scheduling, the design to be simulated is divided into blocks of logic, which may be sequential blocks or combinational blocks. A sequential block is portion of a design that executes on an edge event, such as an edge of a clock. For example, in Verilog, such a sequential block may be expressed using an “always” statement, as follows:

always @ (posedge clk)
q <= d;

In this example, on the positive edge of the clock “clk”, the action “q<=d” is executed. Execution of the block can be skipped if the trigger (the positive edge of the clock “clk”, in this instance), is not true.

There are many types of sequential blocks, and these may trigger on a variety of conditions. Among these are blocks that have both clock and set and/or reset logic. This set and/or reset logic may be asynchronous or synchronous. For example, a synchronous reset is a reset that occurs only on a clock edge. An example of such a reset may be expressed in Verilog RTL as:

always @ (posedge clk)
if (reset)
q <= 0;
else
q <= d;

An asynchronous reset happens immediately, regardless of the state of the clock. An example of such an asynchronous reset may be expressed in Verilog RTL as:

always @ (posedge clk or posedge reset)
if (reset)
q <= 0;
else
q <= d;

Generally, asynchronous sets and/or resets can be handled as if they were clocks by the scheduler module 306. Sequential blocks that have a dependency on an asynchronous set and/or reset may be decomposed into multiple synchronous blocks. One of the synchronous blocks will be dependent on an edge of a clock, one may be dependent on the set signal, and one may be dependent on the reset signal. When this decomposition occurs, the conditional logic used for the set and/or reset is removed.

In addition to synchronous blocks, portions of a design may be combinational blocks. Combinational blocks are blocks that do not depend on a clock edge, and may be executed whenever one of their inputs changes. In event-based simulators, combinational blocks are typically not executed unless one of their inputs has changed. In cycle-based simulators, such as the simulators generated by some embodiments of the present invention, the simulator does not compute whether the inputs to the combinational block have changed or not. However, typically, the combinational blocks are driven by sequential blocks, and if all the inputs to a combinational block are from sequential blocks that are not triggered, then the combinational block need not be executed.

In step 402, the scheduler 306 finds all of the sequential blocks in a design. This is accomplished in some embodiments by traversing the design flow and finding functional blocks (such as “always” blocks in Verilog). A first pass starts at the primary outputs of a design, and traces back through the design until sequential blocks are found. These sequential blocks are added to a list of sequential blocks in the design. A second pass visits the list of sequential blocks that was created by the first pass, looking for additional sequential blocks to add to the end of the list. The traversal of the design flow marks nodes in the flow to avoid cycles and unnecessary recomputation.

In some embodiments, step 402 may be performed by clock analysis module 304, rather than by scheduling module 306, since the sequential blocks may define the clocks in the design.

Next, in step 404, the system determines the set of transition events, and the set of sample events for each block in the design. Transition events are those events that determine when the design component represented by a block should change. Sample events are those events that determine when a block should be sampled (i.e., when the output of a particular block is used).

In some embodiments, the events that trigger a change or a sample include input events, output events, positive edge events, and negative edge events. An input event indicates that the logic in the block is sensitive to at least one of the primary inputs in the design. An output event indicates that the logic in the block is sampled by a primary output of the design. A positive edge event generally includes the name of a clock or other signal (such as a set or reset), and indicates that the block is sensitive to or feeds a sequential block that runs on the positive edge of the indicated clock or signal. Similarly, a negative edge event generally includes the name of a clock or other input signal, and indicates that the block is sensitive to or feeds a sequential block that runs on the negative edge of the indicated clock or signal.

For a sequential block, the set of transition events is based on the clock pin of the sequential block, and certain other signals, such as asynchronous set or reset signals. Generally, the set of transition events will be the positive or negative edge of a clock or other signals on which the sequential block depends.

The set of transition events for a primary input of the design contains the input event. The set of transition events for a combinational block is determined by tracing back from the combinational block along all paths until a sequential block or a primary input is reached, and taking the union of the events in the transition schedules for any blocks encountered while tracing back. In some embodiments, tracing back from the combinational block can be done recursively.

The set of sample events for a primary output is the output event. The sets of sample events for other design components are determined by tracing back from each primary output or sequential block until a sequential block is reached, and combining the transition schedule events for each block of the design in this path.

A set of execution events may be assigned to each block based on its set of transition events or its set of sample events. For sequential blocks, the set of execution events is the set of transition events.

For combinational blocks, which will be accurate whenever they are run, the set of execution events is either the set of transition events or the set of sample events. In some embodiments, the set of execution events is the set of transition events for the block. In some embodiments, the set of execution events is the set of sample events of the block. In some embodiments, the set of execution events is either the set of transition events or the set of sample events, whichever will cause the block to be executed least frequently. For example, if the set of transition events for a combinational block is “posedge clock 1” and “negedge clock 1”, and the set of sample events is “negedge clock1”, then the set of execution events for the block will be the set of sample events for the block. In some embodiments, any “input” events will be removed from the set of execution events.

In step 406, the scheduler 306 partitions the design into the logic that is needed to compute any derived clocks, and the rest of the design. A derived clock is a trigger for at least one sequential block that has non-trivial logic driving it. It should be noted that logic that is equivalent to a buffer or inverter is considered “trivial,” and does not make a clock into a derived clock. Such “trivial” logic will generally be detected during clock analysis, and will not need to be separated out in step 406.

To determine the derived clock logic, the system starts at the clocks found in the clock analysis module 304. For each clock that is not a primary input, the flow of the design is then traced back, stopping at primary inputs, sequential blocks, or other derived clocks. Each node in the flow that computes a derived clock is marked.

Next, in step 408, the system determines an order for all items in each schedule. There are numerous schedules for which a block order may be needed. These include derived clock logic schedules, sequential schedules, and combinatorial schedules. Other schedules, such as an input schedule, an asynchronous schedule, an initial schedule, and a debug schedule may also be present.

In general, there is a sequential schedule for every clock in the design, as determined by the clock analysis module 304. Each such sequential schedule may have a sub-schedule for its positive edge, and a sub-schedule for its negative edge. Generally, a sequential block may be placed in one, and only one of the sequential schedules.

For every unique set of execution events, there may be up to two combinational schedules. One of the combinational schedules is for blocks that have a set of transition events that match the set of execution events of the combinational schedule, and the other is for blocks that have a set of sample events that match the set of execution events of the combinational schedule. All combinational blocks can be placed in exactly one of the combinational schedules.

The input schedule contains all combinational blocks that have the input event in their set of transition events. The asynchronous schedule contains all combinational blocks that have the input event in their set of transition events and the output event in their set of sample events.

Scheduler 306 desirably generates a separate derived clock logic schedule for each derived clock in the design. The blocks that are placed in a derived clock logic schedule are preferably the minimum set of blocks that must execute to correctly compute a value for the derived clock. Each derived clock schedule has one or more sub-schedules, including a sequential sub-schedule for each set of sequential blocks in the derived clock logic schedule that have the same clock, and a combinational sub-schedule. Each sequential sub-schedule may have a positive edge sub-schedule and a negative edge sub-schedule. The set of execution events for the combinational sub-schedule is the union of all of the execution events of all of the combinational blocks that are in the combinational sub-schedule.

The initial schedule contains all combinational blocks that initialize the system. For example, when Verilog is used to describe the hardware device, the initial schedule will contain the Verilog initial blocks and any constant assignments to temporary variables. Generally, the initial schedule will contain every combinational block in the design, to allow initial values to propagate throughout the design when the simulation is initialized.

The debug schedule contains all combinational blocks that need to execute to make nets accurate and the logic to provide debugging output. For example, the debug schedule may include routines that report the values of particular nets, or changes in particular nets to a debugging tool.

In step 408, an order is determined for the derived clock schedules, the sequential schedules, and the combinational schedules. In general, all ordering must maintain data dependencies. Other factors may inform the determination of order within the various schedules.

The derived clock logic schedules should be ordered so that any dependencies between derived clocks are taken into account. To achieve this, in some implementations, the flow of the design is traced back from each derived clock, looking for other derived clocks. This traversal of the flow visits only nodes that are either a derived clock or that make up derived clock logic, as determined by step 406, above. Any derived clocks that are not dependent on any other derived clocks are assigned a depth of one. All other derived clocks are assigned depths that indicate the maximum depth of any chain of derived clocks that is found by tracing back. This depth indicator can be used to sort the derived clocks to provide correct operation of the simulation, and to enhance performance of the simulation.

For sequential blocks, the order may be determined by whether the input to each sequential block is produced by another sequential block, or by a combinational block. In general, sequential block inputs may directly access the output of a preceding block. In certain instances, however, it may be necessary to use double buffering, in which the sequential block input is read from a buffer variable and the output of the preceding block is placed into a buffer variable, so that it will be available the next time that the sequential block is executed. For performance reasons, it is typically preferable to directly access the data, rather than using double buffering. In some instances, however, double buffering may be necessary to produce a correct result.

For sequential blocks that have a combinational block as their input, the block may directly access the input, without the need for double buffering. For sequential blocks that have the same clock, double buffering can be avoided by ordering the blocks in the reverse order of their dependencies. For example, if the input of a sequential block B depends on the output of a sequential block A, and A and B use the same clock, the correct result can be obtained by first executing sequential block B, which directly accesses the current value from block A to form its output, and then executing sequential block A, to update its output. If this order were not used an incorrect result may be reached, since the output of block A may change before it is accessed by block B.

If a sequential block is fed directly by another sequential block that uses a different clock, then double buffering may be needed to ensure a correct result. Double buffering may also be needed where there is a loop of sequential blocks with no intervening combinational block. In this case, one of the sequential blocks in the loop is double buffered, and the rest may directly access the output of previous blocks.

In some embodiments, scheduler 306 determines the block orders by recursively tracing back through the inputs of sequential blocks, looking for chains of sequential blocks with the same clock. If a combinational block is found, a depth of zero is returned. If a sequential block is found, if the sequential block uses the same clock, and the depth is uninitialized, then the traversal continues. If the sequential block that was found uses a different clock, a depth of zero is returned. Otherwise, the stored depth is returned. Each time a value is returned, the depth is incremented. When all blocks in the path have been visited, any sequential blocks having a zero depth are double buffered. All other sequential blocks are sorted into reverse order of their depth.

For combinational blocks, scheduler 306 produces a block order that maintains data dependencies. Additionally, if combinational blocks in a particular schedule represent two different outputs of the same set of logic (e.g., two outputs of the same “always” block in Verilog), then scheduler 306 will place the blocks next to each other in the ordering. If the blocks are not in a cycle, then one of the blocks can be deleted, to avoid executing the same block twice. If the blocks are in a cycle, then neither should be deleted.

Depending on the preferences of the user, scheduler 306 in executing step 408 can attempt to order such identical blocks next to each other, in order to increase performance by having the code for the block in an instruction cache. Alternatively, scheduler 306 can attempt to order combinational blocks so as to place a block that produces data next to the block that consumes the data, in order to improve performance by having the data present in a data cache.

Once an order has been determined for the blocks in each of the schedules, Scheduler 306 can proceed to step 410, in which attempts are made to merge combinational blocks so as to avoid load and store operations between combinational blocks. Generally, when the output of one combinational block serves as the input to another combinational block with the same schedule, the combinational blocks may be merged into a single combinational block.

Finally, in step 412, the various schedules are created, and populated with blocks, using the order determined in step 408, modified as necessary to take into account any combinational blocks that were merged in step 410.

In execution, step 412, scheduler 306 first places the derived clock logic in the correct schedules. In some embodiments, this is done by a recursive algorithm that starts at a derived clock, and traces back until it reaches a combinational block or another derived clock. As the algorithm returns, it places the block into either the sequential or the combinational sub-schedule of the derived clock, depending on the type of block. The set of execution events for the sequential sub-schedules are the triggers for the sequential blocks. The set of execution events for the combinational sub-schedule is the union of the sets of transition events of all the combinational blocks in the combinational sub-schedule. Alternatively, in some embodiments, the sets of sample events may be used instead of the sets of transition events, if this will cause the combinational sub-schedule to execute less frequently.

The derived clock logic schedules are sorted according to the depth that was computed for them in step 408.

In step 412, the sequential and combinational schedules are also created. In some embodiments, this is done using a recursive algorithm that starts first at the sequential blocks, and then at the primary outputs of the design, and traverses back through the flow of the design, visiting blocks in the flow that have not yet been scheduled. As it returns, it places each block in the correct sequential or combinational schedule, according to the type of block, and its set of execution events, as described above.

The sequential blocks in each sequential schedule are sorted in reverse order of depth, as indicated in step 408, and double buffering is added to sequential blocks with a depth of zero. The combinational blocks in the combinational schedules are placed in the order that was determined for them in step 408.

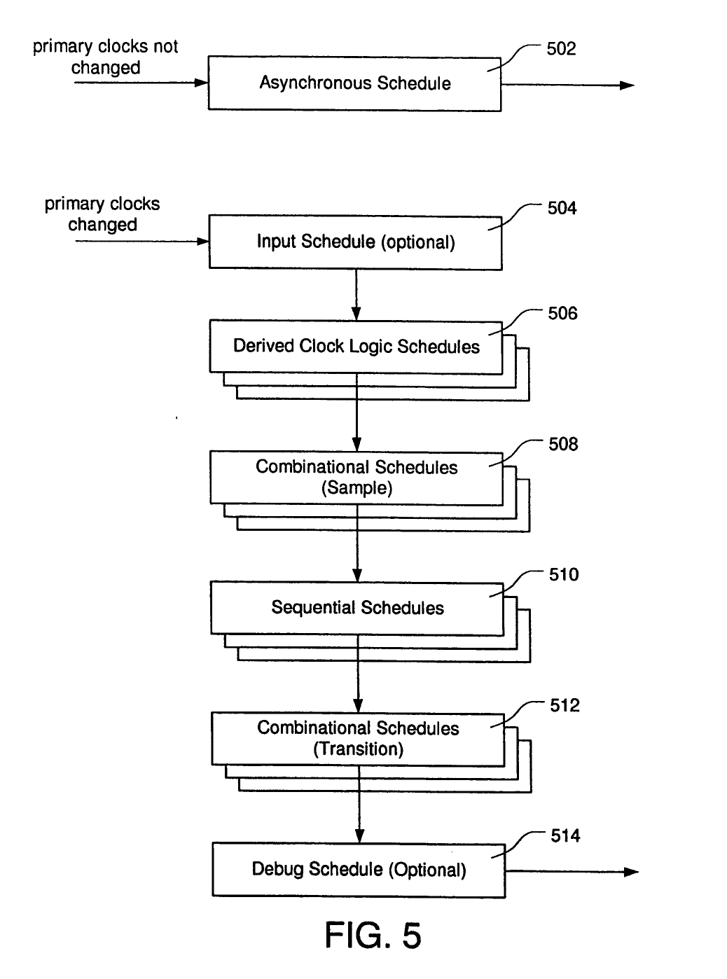

Referring to FIG. 5, the order of execution of the various schedules in the simulation is shown. When the simulation is being executed (e.g., by a user who is using the simulation to develop or test software), the various blocks that make up the design will only be executed when the schedule that they are a part of is executed.

Generally, the asynchronous schedule 502, which, as noted above, contains all combinational blocks that have the input event in their set of transition events and the output event in their set of sample events. The asynchronous schedule 502 is always executed if one of the inputs to the asynchronous schedule 502 changes. Otherwise, if at least one of the clocks has changed, then the simulation checks to see which primary clocks or inputs have changed, and executes the following schedules, depending on the clocks and inputs that have changed.

First, input schedule 504 (which, as noted above, contains all combinational blocks that have the input event in their set of transition events) may be executed, depending on whether changes to the primary inputs need to propagate through the sequential blocks in the design. If so, then the input schedule 504 should be run before the sequential blocks. Otherwise, the input schedule should not be executed.

Next, the derived clock logic schedules 506 (the generation of which by scheduler 306 is described above) are executed. The derived clock logic schedules contain the logic that creates the values of the derived clocks in the design. The derived clock logic schedules 506 are executed by first executing the appropriate sequential sub-schedules for each derived clock logic schedule, based on the clocks and other signals that have changed, and then executing the combinational sub-schedules. The sequential sub-schedules may be executed in any order, but the combinational sub-schedules should be executed in the order of the derived clock logic schedule list that was generated by the scheduler 306. As described above, this order was determined by examining the data dependencies between derived clocks.

Once the derived clock logic schedules have been executed, the simulation checks to see if any of the derived clocks have changed.

Next the combinational schedules 508 (i.e., the sequences of combination blocks generated by scheduler 306 as described above) that have a set of execution events derived from their set of sample events are executed for the active clock edges (and other selected signals, such as asynchronous set and/or reset). These combinational blocks should be executed before the sequential blocks, so that they will provide the correct values when the sequential blocks are executed.

Next, all of the sequential schedules 510 (which were generated by scheduler 306, as described above) for all of the active clock edges (and selected other signals, such as asynchronous set and/or reset) are executed. In some embodiments, since the clock values and transitions are known at this point, only the sequential schedules for which a clock has transitioned are executed.

After the sequential schedules 510 have executed, the combinational schedules 512, for combinational blocks having a set of execution events based on their set of transition events are executed for all active clock edges (and selected other signals, such as asynchronous set and/or reset). The combinational schedules 512 should be executed after the sequential schedules 510 because changes in the output of a sequential block should propagate through the combinational logic that it feeds.

Finally, if debugging is enabled, then the debug schedule 514 should be executed, to generate the necessary debug information.

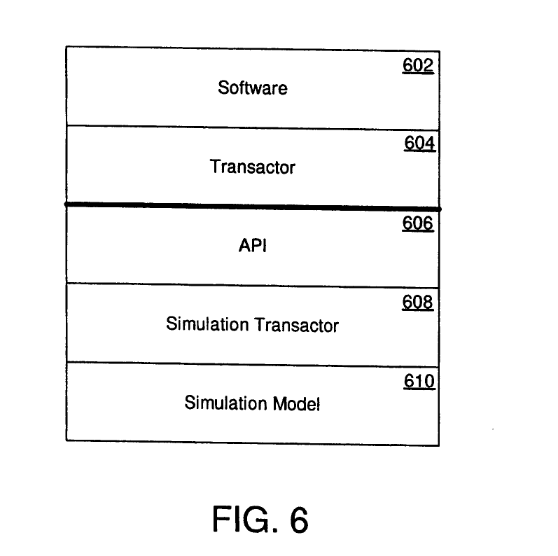

FIG. 6 shows a diagram of a simulation produced by the simulation generator 104 being used with software designed for the electronic device that is being simulated. A software program 602 designed to use the hardware that is being simulated typically uses a transactor 604 to translate between functionality to be provided by the hardware device and an API that is used to communicate with the hardware. The transactor 604 provides an abstraction layer that permits code to be deployed in multiple forms. The transactor 604 uses an application programming interface (API) 606 to communicate with a simulation transactor 608. The simulation transactor 608 translates functionality of the simulator invoked through the API 606 into inputs, outputs, and clock cycles that are handled by the simulation module 610, which is the simulation that was generated by the simulation generator 104. For example, the simulation module 610 may operate cycle-by-cycle, whereas functions provided through the simulation transactor 608 may be multiple cycles. Thus, the simulation transactor 608 may receive an instruction from the API 606 to carry out a multi-cycle function, which will then be executed by the simulation transactor 608 by operating the inputs and outputs of the simulation model 610 on a cycle-by-cycle basis.

For example, if the hardware being simulated is a network interface designed for use on a laptop computer, which supports a PCI (Peripheral Component Interconnect) bus interface, a USB (Universal Serial Bus) port interface, or a PCMCIA (Personal Computer Memory Card International Association) interface, then the simulation module 610 will simulate the hardware of the network interface chip. The software program 602 may be diagnostic software, designed to test the network interface chip. For each bus type (i.e. PCI, USB, and PCMCIA) supported by the chip, there will be a different transactor. Each transactor has its own API. These transactors will all present a common interface to the software program 602, while handling the varying APIs. Each of the APIs in this example will interact with the simulation module 610 using a different simulation transactor, similar to simulation transactor 608 to handle transactions with the hardware.

Advantageously, as can be seen in the example, the transactor 604 can be replaced with a different transactor, without affecting the software program 602. Similarly, by using different transactors, software 602 may remain unmodified, while the system as a whole uses various APIs and simulation transactors, as appropriate for the tests being performed.

The API 606 provides a high-throughput interface between the software program 602 and the simulation model 610. In some embodiments, the API 606, the simulation transactor 608 and the simulation model 610 are all linkable object code which are linked to the software program 602 and the transactor 604. In some embodiments, API 606 may provide functionality that is compatible with known interfaces to hardware simulations, such as PLI. Such compatibility may permit software that has been prepared for use with previously known simulation systems to be used with a software simulation prepared by simulation generator 104.

In some embodiments, if the software program 602 is written to interact directly with the API 606, then the transactor 604 may be omitted. Similarly, some embodiments do not need use the simulation transactor 608 to interface between the API 606 and the simulation model 610.

For some electronic devices, such as microprocessors, the hardware device may be designed to interact with a memory device to obtain its programmed instructions. For such devices, software that executes on the electronic device may be placed in a simulated memory device that may be accessed by a simulation of the hardware device, without requiring use of transactor 604, API 606, or simulation transactor 608.

In some embodiments, the history of inputs and outputs of the simulation module 610 are recorded as the software program 602 interacts with the simulation module 610. The recorded inputs and outputs may be stored in a file.

Later, if the simulation is re-executed, the recorded inputs and outputs may be used to dramatically speed up execution of the simulation. Starting from the first cycle, at each clock cycle, if the inputs to the simulation module 610 are the same as the recorded inputs, then the outputs should be the same as the recorded outputs. This permits the simulation module 610 to produce the correct outputs without executing the simulation, potentially resulting in substantial speedup of the system.

Use of such recorded inputs and outputs may be particularly useful in systems in which the software program 602 always starts by executing the same set of actions, such as initialization of the electronic device. In such cases, the inputs provided by the software program 602 (possibly through the transactor 604) will typically be the same from execution to execution for many cycles after startup. Once the inputs no longer match, the simulation may resume. In some embodiments, this may require that any state associated with synchronous blocks in the system be recorded, so that the simulation may restart in the correct state.

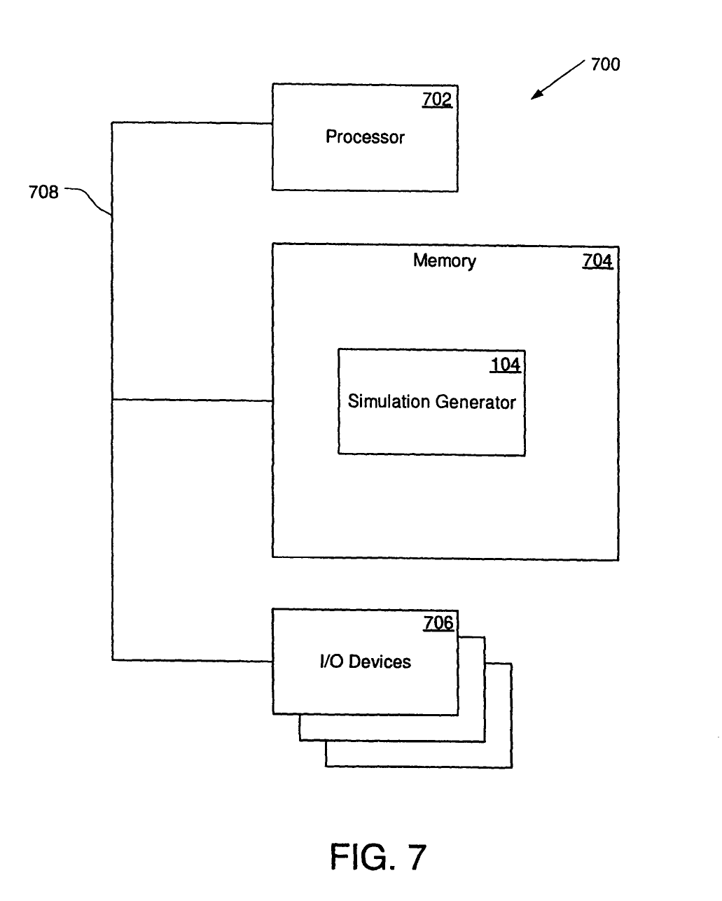

The functionality of the systems and methods described above may be implemented as software on a general purpose computer, such as a general purpose computer 700, as shown in FIG. 7. As can be seen, the general purpose computer 700 includes a processor 702, a memory 704, and I/O devices 706. The processor 702, the memory 704, and the I/O devices 706 are interconnected by a bus 708.

The processor 702 executes instructions that cause the processor 702 to perform functions as embodied in the instructions. These instructions are typically read from the memory 704. In some embodiments, the processor 702 may be a microprocessor, such as an Intel 80×86 microprocessor, a PowerPC microprocessor, or other suitable microprocessor.

The I/O (input/output) devices 706 may include a variety of input and output devices, such as a graphical display, a keyboard, a mouse, a printer, magnetic and optical disk drives, or any other input or output device that may by connected to a computer. The I/O devices 706 may permit instructions and data to be transferred from various computer readable media, such as floppy disks, hard disks, or optical disks into the memory 704.

The memory 704 may be random access memory (RAM), read-only memory (ROM), flash memory, or other types of memory, or any combination of various types of memory (e.g., the memory 704 may include both ROM and RAM). The memory 704 stores instructions which may be executed by the processor 702, as well as data that may be used during the execution of such instructions. In particular, in some embodiments, the memory 704 includes instructions that implement the various modules of the simulation generator 104, including the parser 202, the database formation module 204, the local analysis module 206, the elaboration module 208, the global analysis module 210 (including the reduction module 302, the clock analysis module 304, and the scheduling module 306), and the code generation module 212. These modules may be straightforwardly realized in accordance with the descriptions of their functionality, as described above.

The software implementing these modules may be written in any one of a number of high-level languages, such as C, C++, LISP, or Java. Further, portions of the software may be written as script, macro, or functionality embedded in commercially or freely available software. Additionally, the software could be implemented in an assembly language directed to a microprocessor used in the general purpose computer 700, such as an Intel 80×86, Sun SPARC, or PowerPC microprocessor. The software may be embedded on an article of manufacture including, but not limited to, a “computer-readable medium” such as a floppy disk, a hard disk, an optical disk, a magnetic tape, a PROM, an EPROM, or CD-ROM.

In addition to executing software implementing simulation generator 104, a general-purpose computer, such as the general purpose computer 700 may be used to execute a simulation, such as the simulation 106, produced by the simulation generator 104. In some embodiments, the simulation generator 104 will generate a simulation, such as the simulation 106, that is intended to execute on the same general purpose computer that executed the simulation generator 104. In some embodiments, the simulation 106 generated by the simulation generator 104 may be targeted to execute on a different general purpose computer than the general purpose computer that executed the simulation generator 104.

It will be understood that the general purpose computer 700 is for illustrative purposes only, and that there are many alternative designs of general purpose computers on which software implementing the methods of the invention could be used.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for generating a software object representing operation of at least one hardware device, the method comprising the steps of:
receiving a coded description of the at least one hardware device;
parsing the coded description, thereby describing at least one module of the at least one hardware device;
generating a global analysis result by analyzing the parsed representation using a global analysis framework; and
generating the object based at least in part on the parsed representation, the signal flow graph, and the global analysis result.

2. The method of claim 1 wherein the software object comprises object code.

3. The method of claim 1 wherein the software object comprises a high-level language.

4. The method of claim 3 wherein the high-level language comprises at least one of C, C++, SystemC, and Java.

5. The method of claim 1 wherein the software object comprises low-level assembly code.

6. The method of claim 1 wherein the step of generating a global analysis result comprises generating a signal flow graph comprising a description of a data flow through the at least one module.

7. The method of claim 1 wherein the step of generating a global analysis result comprises generating a signal flow graph comprising a description of a data flow between the at least one module and a second module.

8. The method of claim 1 wherein the coded description is expressed in a high-level language.

9. The method of claim 8 wherein the high-level language comprises a hardware description language.

10. The method of claim 8 wherein the high-level language comprises System C.

11. The method of claim 8 wherein the parsed representation is independent of the high-level language.

12. The method of claim 1 wherein the step of parsing the coded description comprises disregarding at least one extraneous portion of the coded description.

13. The method of claim 1 further comprising the step of adding at least one elaborated module to the parsed representation before the step of generating a global analysis result.

14. The method of claim 1 further comprising the step of executing the software object to simulate the operation of the at least one hardware device.

15. The method of claim 14 wherein a stimulus for the simulation originates in at least one module embedded within the software object.

16. The method of claim 14 wherein a stimulus for the simulation is based at least in part on direct interaction with an API corresponding to the software object.

17. The method of claim 16 wherein a portion of the stimulus originates in at least one transactor.

18. The method of claim 14 wherein a stimulus for the simulation originates in at least one transactor.

19. The method of claim 9 further comprising the step of linking the object code to software that simulates operation of a system, the system comprising the at least one hardware device.
